(19) United States
(12) Patent Application Publication
(10) Pub. No.: US 2011/0135110 A1
(43) Pub. Date: Jun. 9, 2011

(54) Audio device with sound source cassette

(76) Inventor: Albert L. Chen, Irwindale, CA (US)

(21) Appl. No.: 12/592,911

(22) Filed: Dec. 4, 2009

(51) Int. Cl. H04B 1/00

(52) U.S. Cl. 381/86

(57) ABSTRACT

An audio device includes a portable casing, an audio module, and a sound source cassette including a terminal head and a flip cover. The terminal head is supported within a receiving cavity of the portable casing to operatively link with the audio module for communicatively connecting to a portable audio player. The flip cover is movably coupling with the portable casing between an opened position and a closed position. At the opened position, the receiving cavity is exposed for enabling the portable audio player connecting to the terminal head to transmit the audio signal to the audio module. At the closed position, the receiving cavity is enclosed by the flip cover for encasing the portable audio player in the receiving cavity so as to protect the portable audio player and to ensure the portable audio player being connected to the terminal head.

### BACKGROUND OF THE PRESENT INVENTION

1. Field of Invention

The present invention relates to an audio device, and more particularly to an audio device with a sound source cassette, wherein different types of audio players can be protectively housed in the sound source cassette to operatively connect with the audio device, such that the audio device can ensure the connection of the audio player within the sound source cassette without altering the original structural design of the audio player.

2. Description of Related Arts

Outdoors music is very popular in many places such as in beach areas, in patio areas, in campsites or in domestic gardens etc. People usually carry a portable audio device to play music or listen to the radio. The portable audio device generally comprises a portable casing with one or more speakers. Cassette type audio player is the earliest traditional portable audio device. The cassette type audio player comprises a cassette player having an audio housing. The user usually needs to put a cartridge of cassette as an audio source into the audio housing to play the music. Accordingly, the cassette comprise a magnetic tape reeled in a casing and being contacted with a reading head of the cassette type audio player. Therefore, since the cassette is securely housed in the cassette type audio player, the advantage of the cassette type audio player is that the connection between the magnetic tape and the reading head can be ensured especially when the cassette type audio player is carried. However, the drawbacks of the cassette are that the cassette will be damaged by oxidization or magnetized after a time period and the storage of the cassette is relatively limited.

An improved audio player has been developed on the market: the difference between the improved audio player and the traditional audio player is that the cassette is replaced by CD (compact disc). Compared with the traditional cassette audio player, CD provides not only better sound quality, but also can easily storage songs. However, the major drawback of the CD player is that the reading head of the CD player will unable to read the digital data on the CD during the vibration of the CD player. In other words, the CD player cannot be considered as the portable audio device for the user to carry around while playing the music.

Thanks for the improvement of technology in recent years, a dramatically improvement of the audio player has been developed by the IC design. Connected with the technology of the IC and audio music player, the advanced music player storages the music through electric file, and use the simplest way to control it. The most famous audio player is MP3 player. It not only has the compact size, but also is capable of organizing the songs list on its own monitor. Moreover, the user never needs to worry about the space to storage their music

On the other hand, users would always like to listen to the music at their leisure such that the users usually carry a portable music player. However, such portable music player may not come with a speaker. In other words, when people want to share the music with the crowed such as their relative or their friends, the only thing they can do is to bring additional speakers with them. Actually, brings an audio system plus couples of speaker is a terrible experience. Not to mention the problems arise when the weight of the audio system plus couples of speaker is too heavy.

Therefore, a portable audio device compactable with the music player has been developed on the market. Since such portable audio device is specifically designed for connecting with one kind of the music player, existence of different kinds of music players cannot be suitable for the portable audio device. Even though the user just needs to plug the music player into the portable audio device, a tedious connection between the portable audio device and the music player is usually occurred. Take an “i-pod” as an example, the portable audio device generally has a connection slot indented on the outer surface of the casing, wherein the bottom portion of the music player is sat at the connection slot to operatively connect to the portable audio device. The connection between the portable audio device and the music player should be stable enough when the portable audio device is immovable. However, when the portable audio device is being moved around, the music player will be accidentally disconnected from the portable audio device and will damage the connection terminal of the portable audio device. In other words, expect the cassette type audio device, both the CD player and the portable audio device for music player are considered as the desktop type music device, which cannot be carried around when playing the music.

### SUMMARY OF THE PRESENT INVENTION

A main object of the present invention is to provide an audio device with a sound source cassette, wherein different types of audio players can be protectively housed in the sound source cassette to operatively connect with the audio device, such that the audio device can ensure the connection of the audio player within the sound source cassette without altering the original structural design of the audio player.

Another object of the present invention is to provide an audio device with a sound source cassette, wherein the sound source cassette comprises a flip cover which is capable of not only providing a protection of the audio player but also ensuring the audio player being held in proper position, so as to ensure the audio player well connected with the audio device without altering its original structure.

Another object of the present invention is to provide an audio device with a sound source cassette, wherein a terminal head is provided at the flip cover to provide a highly resistant for vibration and external impacts thus ensuring the audio player being firmly connected onto the audio device.

Another object of the present invention is to provide an audio device with a sound source cassette, which is built-in with the audio device such that no separate audio part is required for the user to carry the audio device with the audio player for enjoying music.

Another object of the present invention is to provide an audio device with a sound source cassette, wherein the size and weight of the audio device with sound source cassette is light and compact so as to enable the user easy to carry anywhere and anytime.

Another object of the present invention is to provide an audio device with a sound source cassette, which does not require to alter the original structural design of the traditional cassette type audio device, so as to minimize the manufacturing cost of the audio device incorporating with the sound source cassette and to keep the advantage of the traditional cassette type audio device.

Another object of the present invention is to provide an audio device with a sound source cassette, wherein no expensive or complicated structure is required to employ in the present invention in order to achieve the above mentioned objects. Therefore, the present invention successfully provides an economic and efficient solution for securing and protecting the audio player in the sound source cassette to ensure the proper connection therebetween and for enhancing the portability of the audio device while playing the music.

Accordingly, in order to accomplish the above objects, the present invention provides an audio device for a portable audio player, comprising a portable casing having a receiving cavity for receiving the portable audio player therein and an audio module received in the portable casing for converting an audio signal from the portable audio player into an audible sound.

The audio device further comprises a sound source cassette built-in with the portable casing, wherein the sound source cassette comprises a terminal head and a flip cover.

The terminal head is supported within the receiving cavity to operatively link with the audio module for communicatively connecting to the portable audio player.

The flip cover is movably coupling with the portable casing between an opened position and a closed position. At the opened position, the receiving cavity of the portable casing is exposed for enabling the portable audio player connecting to the terminal head to transmit the audio signal to the audio module. At the closed position, the receiving cavity of the portable casing is enclosed by the flip cover for encasing the portable audio player in the receiving cavity so as to protect the portable audio player and to ensure the portable audio player being connected to the terminal head.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of an audio device with a sound source cassette according to a preferred embodiment of the present invention.

FIG. 2 is a block diagram illustrating the components of the audio device incorporating with the sound source cassette according to the above preferred embodiment of the present invention.

FIG. 3 is a perspective view of the sound source cassette at an opened position according to the above preferred embodiment of the present invention.

FIG. 4 is a side view of the sound source cassette at a closed position according to the above preferred embodiment of the present invention.

### DETAILED DESCRIPTION OF THE PREFERRED EMBODIMENT

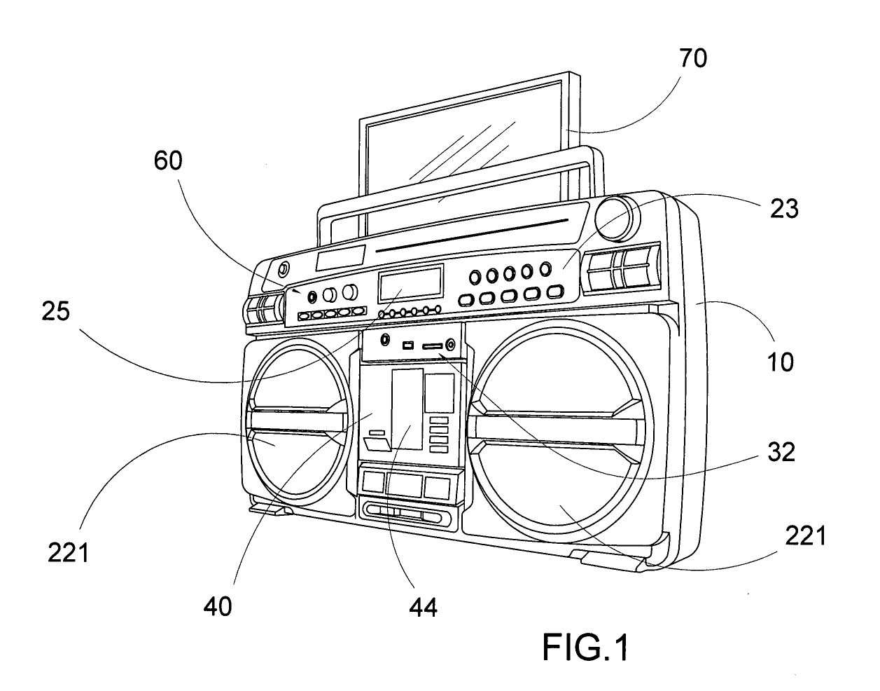

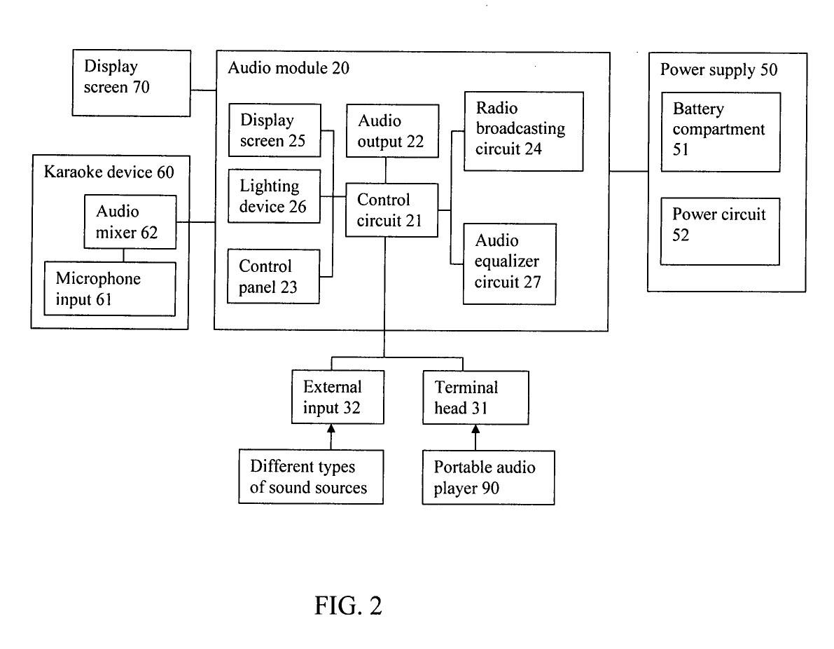

Referring to FIGS. 1 and 2 of the drawings, an audio device according to a preferred embodiment of the present invention is illustrated, wherein the audio device, which is adapted for externally connecting with a portable audio player 90 as a sound source such as an “i-pod” or “i-phone”, comprises a portable casing 10 having a receiving cavity 11 for receiving the portable audio player 90 therein, and an audio module 20 received in the portable casing 10 for converting an audio signal from the portable audio player 90 into an audible sound.

The audio device further comprises a sound source cassette 30 built-in with the portable casing 10, wherein the sound source cassette 30 comprises a terminal head 31 and a flip cover 40.

According to the preferred embodiment, the terminal head 31 is supported within the receiving cavity 11 to operatively link with the audio module 20 for communicatively connecting to the portable audio player 90.

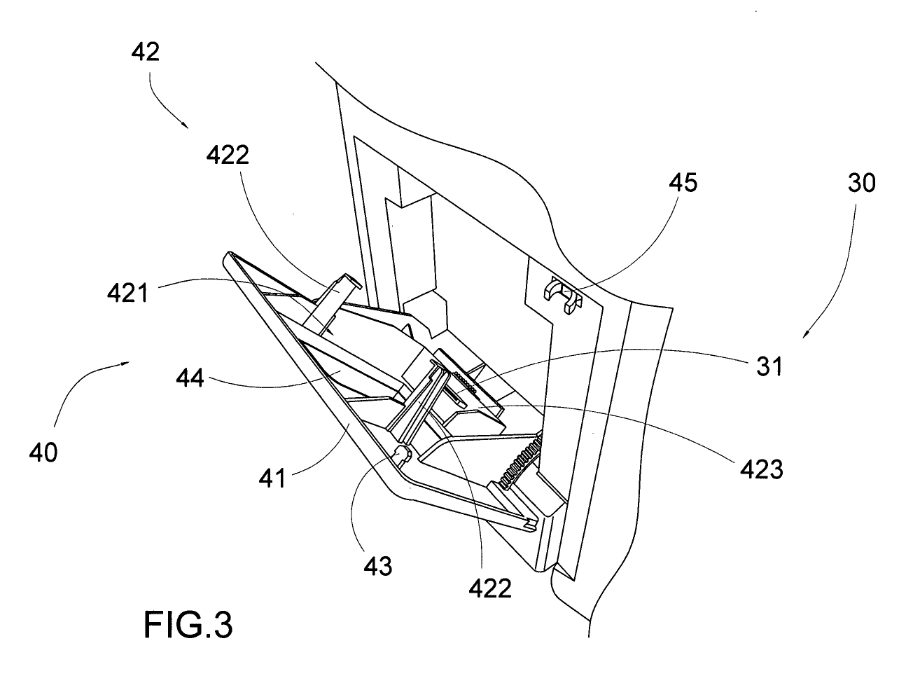

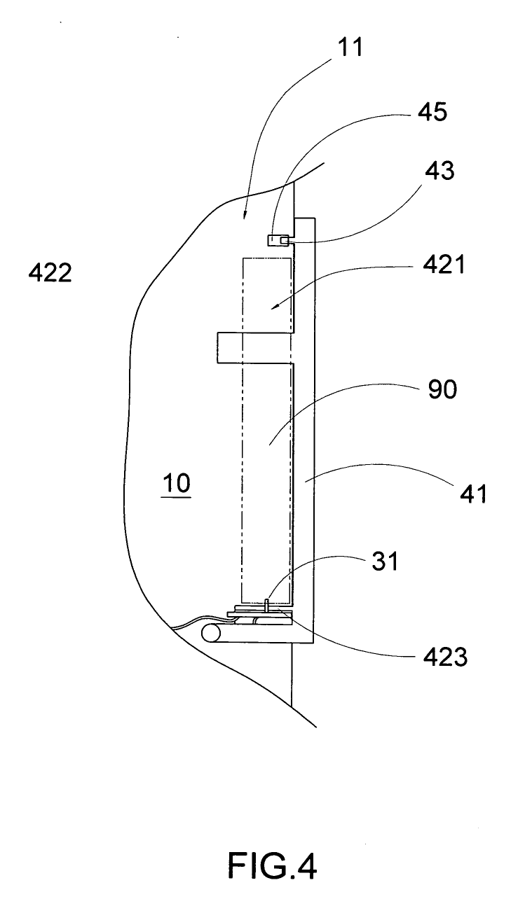

The flip cover 40 is movably coupling with the portable casing 10 between an opened position and a closed position. At the opened position, as shown in FIG. 3, the receiving cavity 11 of the portable casing 10 is exposed for enabling the portable audio player 90 connecting to the terminal head 31 to transmit the audio signal to the audio module 20. At the closed position, as shown in FIG. 4, the receiving cavity 11 of the portable casing 10 is enclosed by the flip cover 40 for encasing the portable audio player 90 in the receiving cavity 11 so as to protect the portable audio player 90 and to ensure the portable audio player 90 being connected to the terminal head 31.

According to the preferred embodiment, the portable casing 10 is shaped and sized to simulate the traditional cassette type audio player so as to provide a retro style audio device.

The audio module 20 comprises a control circuit 21 received in the portable casing 10 to operatively link to the terminal head 31 of the sound source cassette 30 for transmitting the audio signal from the portable audio player 90, and an audio output 22 operatively connected to the control circuit 21 for generating the sound effect. Accordingly, the audio output 22 comprises two or more speaker units 221 spacedly provided at the front side of the portable casing 10.

The audio module 20 further comprises a control panel 23 provided at the front side of the portable casing 10 for the user to selectively operate the control circuit 21, such as an on-and-off function, a radio broadcasting circuit 24 electrically linked to the control circuit 21, a display screen 25 provided at the portable casing 10 for displaying the status of the audio module 20, and a lighting device 26 operatively linked to the control panel 23 for generating a light effect at the portable casing 10 and for illumination purpose.

Accordingly, the control panel 23 is operatively linked to the terminal head 31 for controllably operating the portable audio player 90 when the portable audio player 90 is connected to the terminal head 31. In other words, when the portable audio player 90 is encased within the receiving cavity 11 of the portable casing 10 at the closed position of the flip cover 40, the user is able to operate the control panel 23 to control the portable audio player 90 without actuating the flip cover 40.

The audio module 20 further comprises an audio equalizer circuit 27 operatively linked to the control circuit 21 for signal processing that allows the user to adjust the parameters so as to improve the fidelity of sound output through the audio output 22.

The audio device further comprises a power supply 50 received in the portable casing 10 for electrically connecting to the audio module 20. Accordingly, the power supply 50 comprises a battery compartment 51 provided at a rear side of the portable casing 10 for receiving at least a replaceable battery in the battery compartment 51. In addition, the power supply 50 comprises a power circuit 52 adapted for electrically connecting to an external AC power via a cable. It is worth mentioning that the power supply 50 can forms as a charging source for recharging the portable audio player 90 when the portable audio player 90 is connected to the terminal head 31. In other words, even though the portable audio player 90 is out of battery, the power supply 50 can provide enough electrical power to operate the portable audio player 90.

According to the preferred embodiment, the terminal head 31 is mounted at an inner side of the flip cover 40 such that when the flip cover 40 is pivotally folded at the opened position, the terminal head 31 is correspondingly folded outwardly for the portable audio player 90 being slid at the inner side of the flip cover 40 to operatively connect to the terminal head 31. Therefore, the user is able to easily connect the portable audio player 90 to the terminal head 31 when the flip cover 40 is folded at the opened position. In addition, the terminal head 31 is provided at the flip cover 40 to provide a highly resistant for vibration and external impacts thus ensuring the portable audio player 90 being firmly connected onto the audio device.

As shown in FIGS. 1, 3, and 4, the flip cover 40 comprises a cover panel 41 pivotally coupled with the front side of the portable housing 10 and a player holder 42 provided at an inner side of the cover panel 41 for holding the portable audio player 90 at the inner side of the cover panel 41. The terminal head 31 is securely affixed at the inner side of the cover panel 41.

Accordingly, the cover panel 41 is located between the two speaker units 221 for the user to access, wherein the cover panel 41 of the flip cover 40 is pivotally folded in a hydraulic-like manner. The cover panel 41 has a pivot bottom edge pivotally coupled with the front side of the portable casing 10 such that when the pivot bottom edge of the cover panel 41 is pivotally folded with respect to the front side of the portable casing 10, a top edge of the cover panel 41 is pivotally folded away for exposing the receiving cavity 11 of the portable casing 10. In other words, when the cover panel 41 is pivotally folded at the opened position, a top opening of the receiving cavity 11 is formed for disposing the portable audio player 90 therethrough.

It is appreciated that the cover panel 41 can have one pivot side edge pivotally with the front side of the portable casing 10 such that when the pivot side edge of the cover panel 41 is pivotally folded, another opening side edge of the cover panel 41 is pivotally folded away for exposing the receiving cavity 11. Therefore, when the cover panel 41 is pivotally folded at the opened position, a side opening of the receiving cavity 11 is formed for disposing the portable audio player 90 in a sideward direction.

The flip cover 40 further comprises a cover locker 43 provided at the inner side of the cover panel 41 to releasably engage with the front side of the portable casing 10 and a see-though window 44 formed at the cover panel 41 for enabling the portable audio player 90 being seen when the flip cover 40 is pivotally folded at the closed position.

Accordingly, the cover locker 43 is rearwardly protruded from the inner side of the cover panel 41 to align with a locking groove 45 on the front side of the portable casing 10 such that when the cover panel 41 is pivotally folded on the front side of the portable casing 10, the cover locker 43 is releaseably engaged with locking groove 45 to retain the cover panel 41 in position so as to enclose the receiving cavity 11 of the portable casing 10. In order to release the lock up position of the cover panel 41, the user is able to intentionally press on the cover panel 41 until the cover locker 43 is disengaged with the locking groove 45. Therefore, the cover panel 41 will be automatically and pivotally folded away from the front side of the portable casing 10 in a hydraulic-like manner.

The see-though window 44 is formed at a mid-portion of the cover panel 41 to align with the portable audio player 90 when the portable audio player 90 is connected to the terminal head 31 and is located at the inner side of the cover panel 41.

According to the preferred embodiment, the player holder 42 has a guiding track 421 formed at the inner side of the cover panel 41 for guiding the portable audio player 90 being slid thereat to operatively connect to the terminal head 31. In other words, the guiding track 421 is arranged to guide the portable audio player 90 to connect with the terminal head 31 and to retain the portable audio player 90 at the inner side of the cover panel 41.

As shown in FIGS. 3 and 4, the guiding track 421 comprises two guiding arms 422 perpendicularly extended from the inner side of the cover panel 41 for holding two side edges of the portable audio player 90, and a supporting wall 423 extended below the guiding arms 422 to support the terminal head 31 at the supporting wall 423, such that the terminal head 31 is aligned with the portable audio player 90 when the portable audio player 90 is slid at the inner side of the cover panel 41.

Each of the guiding arms 422 has a L-shape to define a sliding space for holding the respective side edge of the portable audio player 90. Therefore, when the portable audio player 90 is disposed between the two guiding arms 422, the portable audio player 90 can be slid at the inner side of the cover panel 41 to connect with the terminal head 31. Preferably, the two guiding arms 422 are protruded from the inner side of the cover panel 41 at a position close to the top edge thereof.

The supporting wall 423 is perpendicularly extended from the inner side of the cover panel 41 at a position close to the bottom pivot edge thereof for supporting the portable audio player 90 at the inner side of the cover panel 41.

As shown in FIGS. 3 and 4, the supporting wall 432 has a mounting through slot provided thereon, wherein the terminal head 31 is mounted at the bottom side of the supporting wall 432 at a position that the connector head of the terminal head 31 is upwardly extended above the top side of the supporting wall 432 through the mounting through slot thereof. It is worth mentioning that the portable audio player 90 can be firmly held at the inner side of the cover panel 41 by holding the two side edges of the portable audio player 90 by the guiding arms 422 and by supporting the bottom side of the portable audio player 90 on the supporting wall 432. Therefore, the portable audio player 90 can be securely connected to the terminal head 31 while moving the portable casing 10. In other words, the sound source cassette 30 is capable of not only providing a protection of the portable audio player 90 within the receiving cavity 11 but also ensuring the portable audio player 90 being held in proper position, so as to ensure the portable audio player 90 well connected with the terminal head 31 without altering its original structure.

According to the preferred embodiment, the sound source cassette 30 further comprises an external input 32 operatively linked to the audio module 20 for externally connecting with other sound source, wherein the external input 32 comprises at least of a “USB” port, a card reader, and an auxiliary input for selectively different types of sound sources. As shown in FIG. 1, the external input 32 is located at the front side of the portable casing 10 at a position above the flip cover 40.

As shown in FIGS. 1 and 2, the audio device further comprises a karaoke device 60 operatively linked to the audio module 20, wherein the karaoke device 60 comprises a microphone input 61 for connecting a microphone to receive a vocal of a user, and an audio mixer 62 linked to the audio module 20 for mixing the vocal of the user with the audible sound from the portable audio player 90. Therefore, the user is able to not only listen to the music from the portable audio player 90 through the audio device but also sing with the music by the activation of the karaoke device 60.

The audio device may further comprise a display screen 70 foldably mounted to the portable casing 10. Accordingly, the display screen 70 is preferably a LED slidably mounted at the top side of the portable casing 10 to operatively connect to the control circuit 21, wherein the display screen 70 is adapted for playing the video from the portable audio player 90 when the portable audio player 90 is connected to the terminal head 31. Accordingly, the display screen 70 is slidably and upwardly folded on top of the portable casing 10 for usage and is slidably downwardly folded into the interior of the portable casing 10 for storage.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An audio device for a portable audio player, comprising:
a portable casing having a receiving cavity for receiving the portable audio player therein;
an audio module received in said portable casing for converting an audio signal from the portable audio player into an audible sound; and
a sound source cassette, which comprises:
a terminal head supported within said receiving cavity to operatively link with said audio module for communicatively connecting to the portable audio player; and
a flip cover movably coupling with said portable casing between an opened position and a closed position, wherein at said opened position, said receiving cavity of said portable casing is exposed for enabling the portable audio player connecting to said terminal head to transmit said audio signal to said audio module, and at said closed position, said receiving cavity of said portable casing is enclosed by said flip cover for encasing said portable audio player in said receiving cavity so as to protect said portable audio player and to ensure said portable audio player being connected to said terminal head.

2. The audio device, as recited in claim 1, wherein said flip cover comprises a cover panel pivotally coupled with a front side of said portable housing and a player holder provided at an inner side of said cover panel for holding said portable audio player at said inner side of said cover panel.

3. The audio device, as recited in claim 1, wherein said terminal head is mounted at an inner side of said flip cover such that when said flip cover is pivotally folded at said opened position, said terminal head is correspondingly folded outwardly for said portable audio player being slid at said inner side of said flip cover to operatively connect to said terminal head.

4. The audio device, as recited in claim 2, wherein said terminal head is mounted at an inner side of said flip cover such that when said flip cover is pivotally folded at said opened position, said terminal head is correspondingly folded outwardly for said portable audio player being slid at said inner side of said flip cover to operatively connect to said terminal head.

5. The audio device, as recited in claim 2, wherein said player holder has a guiding track formed at said inner side of said cover panel for guiding said portable audio player being slid thereat to operatively connect to said terminal head.

6. The audio device, as recited in claim 4, wherein said player holder has a guiding track formed at said inner side of said cover panel for guiding said portable audio player being slid thereat to operatively connect to said terminal head.

7. The audio device, as recited in claim 5, wherein said guiding track comprises two guiding arms perpendicularly extended from said inner side of said cover panel for holding two side edges of said portable audio player, and a supporting wall extended below said guiding arms to support said terminal head at said supporting wall, such that said terminal head is aligned with said portable audio player when said portable audio player is slid at said inner side of said cover panel.

8. The audio device, as recited in claim 6, wherein said guiding track comprises two guiding arms perpendicularly extended from said inner side of said cover panel for holding two side edges of said portable audio player, and a supporting wall extended below said guiding arms to support said terminal head at said supporting wall, such that said terminal head is aligned with said portable audio player when said portable audio player is slid at said inner side of said cover panel.

9. The audio device, as recited in claim 2, wherein said cover panel has a pivot bottom edge pivotally coupled with said front side of said portable casing such that when said pivot bottom edge of said cover panel is pivotally folded with respect to said front side of said portable casing, a top edge of said cover panel is pivotally folded away for exposing said receiving cavity.

10. The audio device, as recited in claim 4, wherein said cover panel has a pivot bottom edge pivotally coupled with said front side of said portable casing such that when said pivot bottom edge of said cover panel is pivotally folded with respect to said front side of said portable casing, a top edge of said cover panel is pivotally folded away for exposing said receiving cavity.

11. The audio device, as recited in claim 8, wherein said cover panel has a pivot bottom edge pivotally coupled with said front side of said portable casing such that when said pivot bottom edge of said cover panel is pivotally folded with respect to said front side of said portable casing, a top edge of said cover panel is pivotally folded away for exposing said receiving cavity.

12. The audio device, as recited in claim 2, wherein said flip cover, which is pivotally folded in a hydraulic-like manner, further comprises a cover locker provided at said inner side of said cover panel to releasably engage with said front side of said portable casing and a see-though window formed at said cover panel for enabling said portable audio player being seen when said flip cover is pivotally folded at said closed position.

13. The audio device, as recited in claim 8, wherein said flip cover, which is pivotally folded in a hydraulic-like manner, further comprises a cover locker provided at said inner side of said cover panel to releasably engage with said front side of said portable casing and a see-though window formed at said cover panel for enabling said portable audio player being seen when said flip cover is pivotally folded at said closed position.

14. The audio device, as recited in claim 11, wherein said flip cover, which is pivotally folded in a hydraulic-like manner, further comprises a cover locker provided at said inner side of said cover panel to releasably engage with said front side of said portable casing and a see-though window formed at said cover panel for enabling said portable audio player being seen when said flip cover is pivotally folded at said closed position.

15. The audio device, as recited in claim 1, wherein said audio module comprises a control panel operatively linked to said terminal head for controllably operating said portable audio player when said portable audio player is connected to said terminal head.

16. The audio device, as recited in claim 8, wherein said audio module comprises a control panel operatively linked to said terminal head for controllably operating said portable audio player when said portable audio player is connected to said terminal head.

17. The audio device, as recited in claim 14, wherein said audio module comprises a control panel operatively linked to said terminal head for controllably operating said portable audio player when said portable audio player is connected to said terminal head.

18. The audio device, as recited in claim 1, wherein said sound source cassette further comprises an external input operatively linked to said audio module for externally connecting with other sound source, wherein said external input comprises a “USB” port, a card reader, and an auxiliary input for selectively different types of sound sources.

19. The audio device, as recited in claim 8, wherein said sound source, cassette further comprises an external input operatively linked to said audio module for externally connecting with other sound source, wherein said external input comprises a “USB” port, a card reader, and an auxiliary input for selectively different types of sound sources.

20. The audio device, as recited in claim 17, wherein said sound source cassette further comprises an external input operatively linked to said audio module for externally connecting with other sound source, wherein said external input comprises a “USB” port, a card reader, and an auxiliary input for selectively different types of sound sources.

21. The audio device, as recited in claim 1, further comprising a karaoke device operatively linked to said audio module, wherein said karaoke device comprises a microphone input for connecting a microphone to receive a vocal of a user, and an audio mixer linked to said audio module for mixing said vocal of said user with said audible sound from said portable audio player.

22. The audio device, as recited in claim 14, further comprising a karaoke device operatively linked to said audio module, wherein said karaoke device comprises a microphone input for connecting a microphone to receive a vocal of a user, and an audio mixer linked to said audio module for mixing said vocal of said user with said audible sound from said portable audio player.

23. The audio device, as recited in claim 20, further comprising a karaoke device operatively linked to said audio module, wherein said karaoke device comprises a microphone input for connecting a microphone to receive a vocal of a user, and an audio mixer linked to said audio module for mixing said vocal of said user with said audible sound from said portable audio player.
